(19) United States
(12) Patent Application Publication
(10) Pub. No.: US 2007/0180619 A1
(43) Pub. Date: Aug. 9, 2007

(54) Profiling surface

(76) Inventors: Stephen Hayes, West Midlands (GB); Stephen Hollyoak, West Midlands (GB)

Correspondence Address: DEWITT ROSS & STEVENS S.C., 8000 EXCELSIOR DR, SUITE 401, MADISON, WI, 53717-1914, US

(21) Appl. No.: 10/598,619

(22) PCT Filed: Apr. 19, 2005
(86) PCT No.: PCT/GB05/01490

§ 371 Date: Sep. 6, 2006

(30) Foreign Application Priority Data
Apr. 23, 2004 (GB) 0409111.2

(51) Int. Cl. A61G 7/015

(52) U.S. Cl. 5/618

(57) ABSTRACT

A bed (10) or trolley or similar consists of a platform (20) comprising a back section (21), seat section (22), thigh section (23) and foot section (24). The “auto contour” controls are configured such that when the sections (21, 23, 24) are driven from a flat condition, the back (21) and thigh (23) sections are moved simultaneously, until they reach the same angle. The thigh section (23) then remains at that position and the back section (21) continues until it reaches its maximum position. To lower the sections using the “auto contour” controls only the back section (21) is driven down until it reaches the equivalent position to the thigh section (23) and then both sections (21, 23) are driven down simultaneously. The patient is held in a relatively constant position, thereby reducing the shear between the patient's skin and the support surface.

The present invention relates to a bed, trolley or similar apparatus and more particularly to a bed, trolley or similar apparatus with a profiling support surface.

It is known to have beds with profiling surfaces to overcome many of the difficulties associated with positioning and mobilisation of patients. Such profiling surfaces can offer many advantages, including reduced risk of injury to staff and patients, increased patient independence, faster recovery from illness and improved cost-effectiveness.

A number of beds with profiling surfaces are known that provide good upright positioning which usually involves raising the back section and the thigh section of the surface. Some beds also provide an “auto contour” control that enables the patient to be positioned in an upright position in one operation. During “auto contour” control, the back and thigh sections are driven simultaneously until they reach their fully raised or fully lowered positions. If the sections begin from a flat condition then the patient is maintained in a relatively constant position, along the axis of the bed during the profiling of the sections.

When the bed is fully profiled and the “auto-contour” control is used to flatten the sections, the back section and the thigh section are driven simultaneously until they reach their fully flat end positions. However, because the thigh section has less angular travel than the back section, the thigh section reaches the fully flat position much earlier, so that as the back section continues to be lowered the patient is moved along the axis of the bed resulting in shear between the patient's skin and the support surface.

Similarly, because the thigh section and back section are driven simultaneously, any reduction of the back section angle using the “auto-contour” control will consequentially reduce the thigh section angle such that the thigh section may reach a flat position whilst the back section is still in a relatively elevated position. Increased shear between the patients skin and the mattress surface results.

The invention seeks to make improvements.

According to the invention there is provided a profiling surface for a bed or trolley comprising a frame supporting the surface, the surface having at least a back section and a thigh section, the back and thigh sections pivotally connected to the frame for movement from a horizontal position to a raised position, control means to drive actuators to profile the sections, the control means raising the back and thigh sections simultaneously from a flat position until they reach a substantially equivalent angle, the thigh section remaining in that position and the back section continuing to be raised until it reaches its maximum position, and for return of the sections to the flat position, the control means only lowering the back section until it reaches a substantially equivalent position to the thigh section, and then simultaneously lowering both the back and thigh sections to the flat position. In this way, the patient is held in a relatively constant position during the profiling of the sections thereby reducing the shear between the patient's skin and the support surface.

Preferably, at higher angles of profile any adjustments only result in adjustments to the back section angle, thereby maintaining the position of the patient relative to the axis of the bed. Advantageously, this form of control allows the majority of patients to use just the “auto contour” control to alter their position when in a profiled position.

In a preferred embodiment, the actuators driving the back and thigh sections each have limit switches to detect their fully extended condition and their fully retracted condition respectively, the back section actuator further provided with a third integrated limit switch between the two end of travel limit switches, the third limit switch position substantially equating to the fully extended condition of the thigh actuator. Preferably, when the back section actuator is in the zone between the third limit switch and its fully extended limit switch, any adjustment of the profile angle only results in actuation of the back section actuator and not the thigh section actuator.

The present invention allows a simple “one button” adjustment of the profiled position, without the need for software within the control system, enabling a good profiling action to be attained at a very low cost.

The present invention will now be described by way of example only, with reference to the following drawings, of which

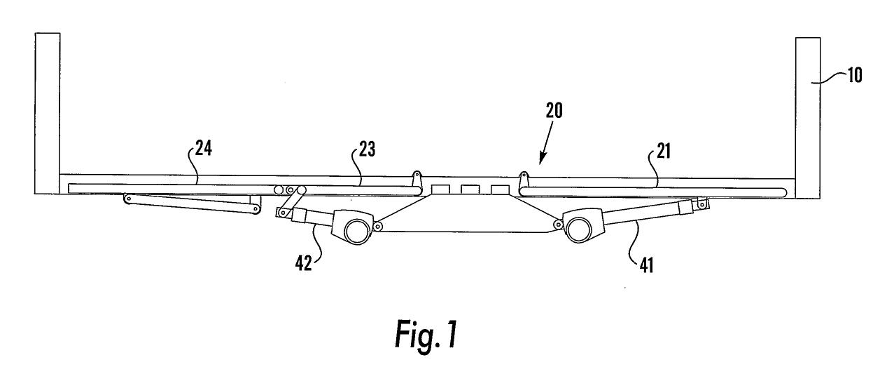

FIG. 1 shows a schematic view of the bed platform in a flat position;

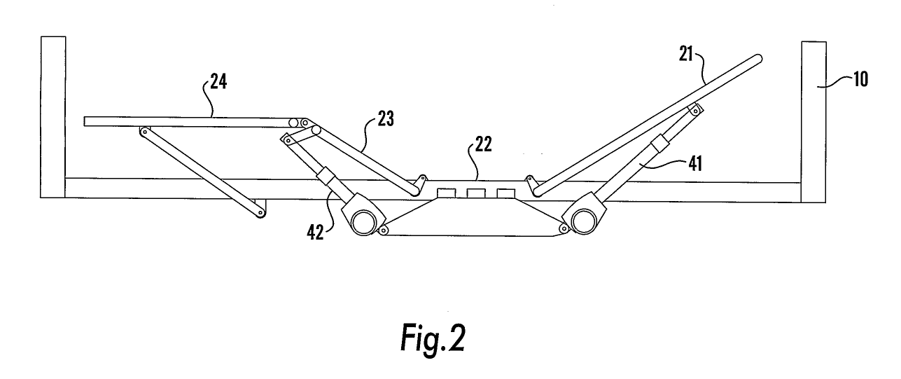

FIG. 2 shows a schematic view of the bed platform wherein the raised back section and thigh section position are raised to equal angles; and

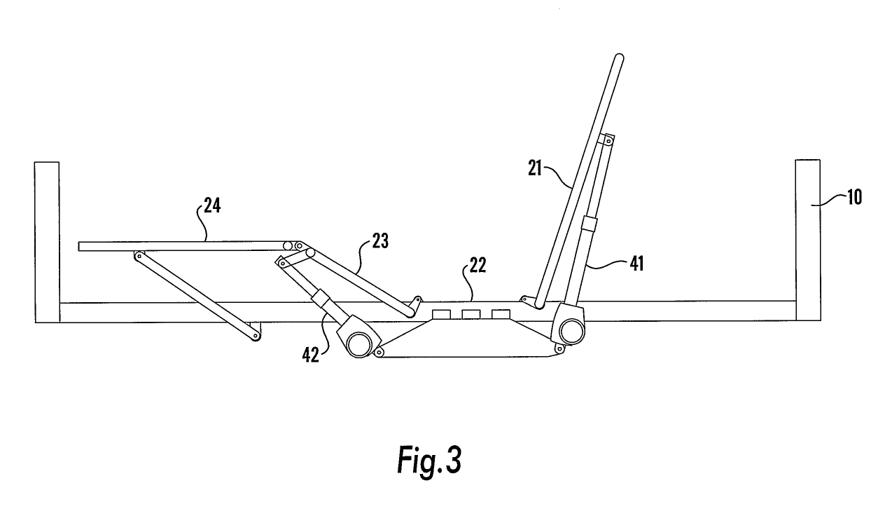

FIG. 3 shows a schematic view of the bed platform where the back section is raised further than in FIG. 2.

Referring to FIG. 1, a bed 10 consists of a platform 20 comprising a back section 21, seat section 22 and thigh section 23 and foot section 24.

Normally, electrically operated linear actuators, used for driving the bed sections, only have two limit switches, one to detect their fully extended condition and one to detect their fully retracted condition. These switches are used to sense the ends of travel of the actuator and interrupt electrical power to the motors.

In a preferred embodiment, the present invention provides a third integrated limit switch in the back section actuator 41, partway between the two end of travel limit switches. This third limit switch is positioned such that it is activated at the same point as the thigh actuator 42 fully extended condition.

The actuator controls are configured such that when the sections 21,23,24 are driven from a flat position as shown in FIG. 1 using the “auto contour” control, the back 21 and thigh 23 sections are moved simultaneously, until they reach a substantially equivalent angle as shown in FIG. 2. The thigh section 23 then remains at that position and the back section 21 continues to be driven by actuator 41 until it reaches its maximum position as shown in FIG. 3. If the “auto-contour” control is then used to lower the sections, then only the back section 21 is driven down until it reaches a substantially equivalent position to the thigh section 23 in FIG. 2. At this point the thigh section 23 will then begin to drive down simultaneously with the back section 21. This will result in the patient being held in a relatively constant position, thereby reducing the shear between the patient's skin and the mattress surface.

At higher angles of profile any adjustments using the “auto-contour” control only results in adjustments to the back section 21 as shown in FIG. 3 thereby maintaining the position of the patient relative to the axis of the bed. This form of control allows the majority of patients to use only the “auto contour” control to alter their position when in a profiled position. In conventional beds adjustment of the back section would have to be performed using a separate control button. This preferred arrangement allows a simple “one button” adjustment of the profiled position, without the need for software within the control system. This means that a good profiling action can be attained at a very low cost.

The arrangement incorporates a third limit switch within the back section actuator 41 in a position that substantially equates to the fully extended condition of the thigh actuator 42. The actuator controls are configured such that when the back section actuator 41 is in the zone between this limit switch and its fully extended limit switch, any adjustment of “auto contour” has no effect on the thigh section actuator 42. Thereby, the thigh section 23 remains in its fully raised position until the back section 21 is lowered to a substantially equivalent angle.

1. A profiling surface for a bed or trolley comprising a frame supporting the surface, the surface having at least a back section and a thigh section, the back and thigh sections pivotally connected to the frame for movement from a horizontal position to a raised position, control means driving actuators to profile the sections, the control means raising the back and thigh sections simultaneously from a flat position until they reach a substantially equivalent angle, the thigh section remaining in that position and the back section continuing to be raised until it reaches its maximum condition, and for return of the sections to the flat position, the control means initially only lowering the back section until it reaches a substantially equivalent position to the thigh section position, and then simultaneously lowering both the back and thigh sections to the flat position.

2. A profiling surface for a bed or trolley as claimed in claim 1 wherein at higher angles of profile any adjustments only result in adjustments to the back section angle.

3. A profiling surface for a bed or trolley as claimed in claim 1 wherein the actuators driving the back and thigh sections each have limit switches to detect their fully extended condition and their fully retracted condition respectively, the back section actuator further provided with a third integrated limit switch between the two end of travel limit switches, the third limit switch position substantially equating to the fully extended condition of the thigh actuator.

4. A profiling surface for a bed or trolley as claimed in claim 3 wherein when the back section actuator is in the zone between the third limit switch and its fully extended limit switch, any adjustment of the profile angle only results in actuation of the back section actuator and not the thigh section actuator.

5. (canceled)

6. A profiling surface for a bed or trolley comprising:
(i) a frame supporting the profiling surface;
(ii) a back section pivotally connected to the frame, the back section including a back section actuator drivable to angularly incline the back section between horizontal and non-horizontal positions;
(iii) a thigh section pivotally connected to the frame, the thigh section including a thigh section actuator drivable to angularly incline the thigh section between horizontal and non-horizontal positions;
wherein:
a. during an auto-contour raise command issued by a user, the actuators are controlled to:
(1) simultaneously pivotally raise the back and thigh sections toward each other if the back and thigh sections are each between a respective lowermost inclination and a respective intermediate inclination greater than the lowermost inclination;
(2) raise the back section, without raising the thigh section, if the back section is between its intermediate inclination and a maximum elevation; and
b. during an auto-contour lower command issued by a user, the actuators are controlled to:
(1) lower the back section, without lowering the thigh section, if the back section is between its maximum inclination and its intermediate inclination;
(2) simultaneously pivotally lower the back and thigh sections away from each other if the back and thigh sections are each between their respective intermediate elevations and their respective lowermost inclinations.

7. The profiling surface of claim 6 wherein the angular inclination of the back section at the intermediate inclination of the back section is at least substantially equal to the angular inclination of the thigh section at the intermediate inclination of the thigh section.

8. The profiling surface of claim 7 wherein the angular inclination of the back section at the lowermost inclination of the back section is at least substantially equal to the angular inclination of the thigh section at the lowermost inclination of the thigh section.

9. The profiling surface of claim 6 wherein the actuators are incapable of raising the thigh section past its intermediate inclination

10. The profiling surface of claim 6 further comprising:
a. back section limit switches triggered upon inclination of the back section to each of its lowermost inclination, intermediate inclination, and maximum elevation; and
a. thigh section limit switches triggered upon inclination of the thigh section to each of its lowermost inclination and intermediate inclination.

11. The profiling surface of claim 10 wherein the actuators are incapable of inclining the thigh section between the triggering of the back section limit switches at the intermediate inclination of the back section and the maximum elevation of the back section.

12. The profiling surface of claim 6 further comprising a single inclination control, such as a single button, which receives the user-issued auto-contour raise command and the user-issued auto-contour lower command.

13. The profiling surface of claim 6 wherein, during an auto-contour raise or lower command issued by a user, the actuators are controlled to maintain the back and thigh sections in at least substantially equivalent angular inclinations if the back and thigh sections are each between their respective lowermost and intermediate inclinations.

14. A method for actuating a profiling surface for a bed or trolley, wherein:
(i) the bed or trolley includes a frame supporting the profiling surface,
(ii) the profiling surface includes a back section pivotally connected to the frame, the back section including at least one back section actuator drivable to angularly incline the back section between horizontal and non-horizontal positions,
(iii) the profiling surface includes a thigh section pivotally connected to the frame, the thigh section including at least one thigh section actuator drivable to angularly incline the thigh section between horizontal and non-horizontal positions,
the method comprising the steps of:
a. during an auto-contour raise command issued by a user, commanding the actuators to:
(1) simultaneously pivotally raise the back and thigh sections toward each other if the back and thigh sections are each between a respective lowermost inclination and a respective intermediate inclination greater than the lowermost inclination; and
(2) raise the back section, without raising the thigh section, if the back section is between its intermediate inclination and a maximum elevation; and
b. during an auto-contour lower command issued by a user, commanding the actuators to:
(1) lower the back section, without lowering the thigh section, if the back section is between its maximum inclination and its intermediate inclination;
(2) simultaneously pivotally lower the back and thigh sections away from each other if the back and thigh sections are each between their respective intermediate elevations and their respective lowermost inclinations.

15. The method of claim 14 wherein the angle of the back section at the intermediate elevation for the back section is at least substantially equivalent to the angle of the thigh section at the intermediate elevation for the thigh section.

16. The method of claim 14 wherein the angle of the back section at the lowermost elevation for the back section is at least substantially equivalent to the angle of the thigh section at the lowermost elevation for the thigh section.

17. The method of claim 14 wherein auto-contour raise command and auto-contour lower command are user-actuated from a single inclination control, such as a single button.

18. The profiling surface of claim 14 wherein, during an auto-contour raise or lower command issued by a user, the actuators are controlled to maintain the back and thigh sections in at least substantially equivalent angular inclinations if the back and thigh sections are each between their respective lowermost and intermediate inclinations.
